(19) United States
(12) Patent Application Publication
(10) Pub. No.: US 2025/0387884 A1
(43) Pub. Date: Dec. 25, 2025

(54) GYRATORY SOCKET TOOL

(71) Applicant: Ángel D. De Jesús-Wonderwood, Yabucoa, PR (US)

(72) Inventor: Ángel D. De Jesús-Wonderwood, Yabucoa, PR (US)

(21) Appl. No.: 18/750,631

(22) Filed: Jun. 21, 2024

(51) Int. Cl. B25B 13/48; B25B 13/46; B25B 21/00

(52) U.S. Cl. CPC B25B 13/481; B25B 13/46; B25B 21/004; B25B 21/007

(57) ABSTRACT

A gyratory socket tool for adjusting a fastener, useful for working in restricted places where placement of a tool, operational space and/or environment conditions where hand placement, and/or movement of hand or tools is otherwise difficult. The gyratory socket tool facilitates working remotely using a ratchet with or without an extension bar and an additional extension bar. Internal mechanisms rotate while the exterior body remains stationary, with mechanical forces applied via a rack and pinion type system. The ratchet and extension bar serve to provide mechanical motion, additional extension bar(s) stabilize the gyratory socket tool when in operation. Mechanical motion may be provided by a ratchet, impact driver or drill so that the cylindrical part inside rotates to loosen or tighten a fastener.

### BACKGROUND OF THE INVENTION

### 1) Field of the Invention

The invention relates in general to the field of socket fastening tools for a ratchet, and

more particularly, to a socket type fastening tool with a cylindrical body and an open slot.

### 2) Description of related art

The field of mechanical tools has seen numerous advancements over the years. One area that has been of particular interest is the development of fastening tools. These tools are essential for a variety of tasks, from assembling furniture to repairing machinery. Fastening tools come in a variety of shapes and sizes, each designed to perform a specific function. However, there are certain challenges associated with the use of these tools. For instance, some tools may not provide the necessary grip, making it difficult to fasten or unfasten screws or bolts. Additionally, some tools may not be suitable for use in tight spaces, limiting their utility. Therefore, there is a continuous quest for improvements in the design and functionality of fastening tools.

These and other objects, features, and advantages of the present invention will become more readily apparent from the attached drawings and the detailed description of the preferred embodiments, which follow.

### SUMMARY OF THE INVENTION

Bearing in mind the problems and deficiencies of the prior art, it is therefore an object of the present invention to provide a fastening tool designed for fastening operations. The tool features a socket configuration and has a body structure with a cylindrical shape that provides a structural form to the tool. The tool also includes a slot that is open and designed to accommodate a component. The tool is designed for use in various applications including industrial, automotive repair and maintenance, construction and assembly operations, home repair and maintenance, mechanical and engineering, manufacturing and production, aerospace and aviation maintenance and repair, marine repair and maintenance, electrical and electronic repair and maintenance, plumbing repair and maintenance, heavy machinery repair and maintenance, railway repair and maintenance, mining operations and maintenance, oil and gas operations and maintenance, and agricultural machinery repair and maintenance.

The gyratory socket tool is useful for working in uncomfortable places where placement of a tool is restricted, operational space and/or environment restricts hand placement, and/or there is restricted space in which to move a tool or hands. The gyratory socket tool facilitates working remotely using a ratchet with or without an extension bar and an additional extension bar. The ratchet and extension bar serve to provide mechanical motion, the additional extension bar to stabilize the gyratory socket tool when in operation. Mechanical motion may be provided by a ratchet, impact driver or a drill so that the cylindrical part inside rotates to loosen or tighten a fastener. Still other objects and advantages of the invention will in part be obvious and will in part be apparent from the specification.

The above and other objects, which will be apparent to those skilled in the art, are achieved in the present invention which is directed to a gyratory socket assembly for adjusting a fastener, the gyratory socket assembly including: an exterior cylindrical body having an exterior cylindrical wall, the exterior cylindrical wall having a pinion hole for engagement with a pinion bar, and a top face wherein a top opening is disposed in the center of said top face.

The pinion bar is disposed through the pinion hole, wherein the pinion bar has an exterior face having a ratchet hole. There exists a pinion gear disposed in the interior of the exterior cylindrical body; wherein the pinion bar engages with an interior cylindrical body. The pinion bar can be rotated by engagement with a ratchet or a drill with a compatible fitting.

The interior cylindrical body has a wide diameter portion and a narrow diameter portion, where the wide diameter portion has a rack to interface with the pinion gear. The interior cylindrical body is aligned coaxially with the exterior cylindrical body and allows coaxial rotation between the exterior cylindrical body and the interior cylindrical body.

The interior cylindrical body has lower surface disposed of on the wide diameter portion, where a socket open end is located. The socket open end has an edge and at least one internal face along the socket open end edge, which engages with the fastener.

The gyratory socket assembly utilizes a retention washer recessed into the exterior cylindrical body to secure the interior cylindrical body while still permitting rotation of the interior cylindrical body independent of the exterior cylindrical body.

The gyratory socket contains a thru-hole extending from a top surface through the interior cylindrical body to the socket lower surface to provide a clearance should the fastener be connected to a longer male threaded segment.

The gyratory socket assembly can utilize an extension bar to stabilize the gyratory socket assembly during use. The thru-hole disposed on-center on the top surface of the interior cylindrical body is used for engagement with the extension bar. In other embodiments, a first extension hole can be created on the top surface of the interior cylindrical body off-center from the thru-hole. In other embodiments, a second extension hole can be created on the exterior cylindrical wall.

Common extension bars and ratchet drives have sizes of ¼″, ⅜″, ½″, ¾″, 1″ and larger. Additional embodiments of the gyratory socket assembly the gyratory socket assembly maintain extension holes and/or ratchet hole sizes to be compatible with tools used in industry.

Varying sizes imply varying degrees of torque required for manipulation, larger implying higher levels of mechanical assistance for manipulation of a fastener. As such, material selection (alloys, metals) used in fabrication of the gyratory socket tool should be considered in regard to forces applied. Additionally, the size of the extension holes and the ratchet hole may vary in size within the same embodiment to offer options of operational use.

In other embodiments, the gyratory socket assembly has a socket open end which is hexagonally shaped to engage with specific fasteners.

In other embodiments, the gyratory socket assembly has a socket open end shaped to match and engage with the geometry of a standard or non-standard fastener of a given geometry.

Another aspect of the present invention is directed to a method for using the gyratory socket assembly for adjustment of a fastener. A stepwise process includes:
a. engaging a ratchet in the ratchet hole of a pinion bar;
b. engaging a socket extension in one of a plurality of the extension holes;
c. ensuring the pinion bar is positioned in the pinion hole and engaged with the interior cylindrical body;
d. placing the socket adjacent to the elongated male threaded fastener;
e. placing the socket around the elongated male threaded fastener wherein the elongated male threaded fastener extends through the socket along a socket central axis;
f. rotating the ratchet engaged to the pinion hole to loosen or tighten the fastener;
g. stabilizing the gyratory socket assembly by restricting motion of the exterior cylindrical body using the socket extension;
h. continuing to rotate the socket extension until the fastener is at a desired position.

An alternate method utilizes a drill or driver (instead of a ratchet) to rotate the pinion bar.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1A is an isometric view of an interior cylinder body;

FIG. 1B is a combined isometric view of the interior cylinder body and an external cylindrical body;

FIG. 2 is an isometric view of a pinion bar;

FIG. 3 is an isometric view of the exterior cylinder body;

FIG. 4 is a retention washer;

FIG. 5 is a gyratory socket tool assembly;

FIG. 6 is illustration of the gyratory socket tool as used with external components; and

FIG. 7 is a flowchart showing a method for using the socket assembly according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

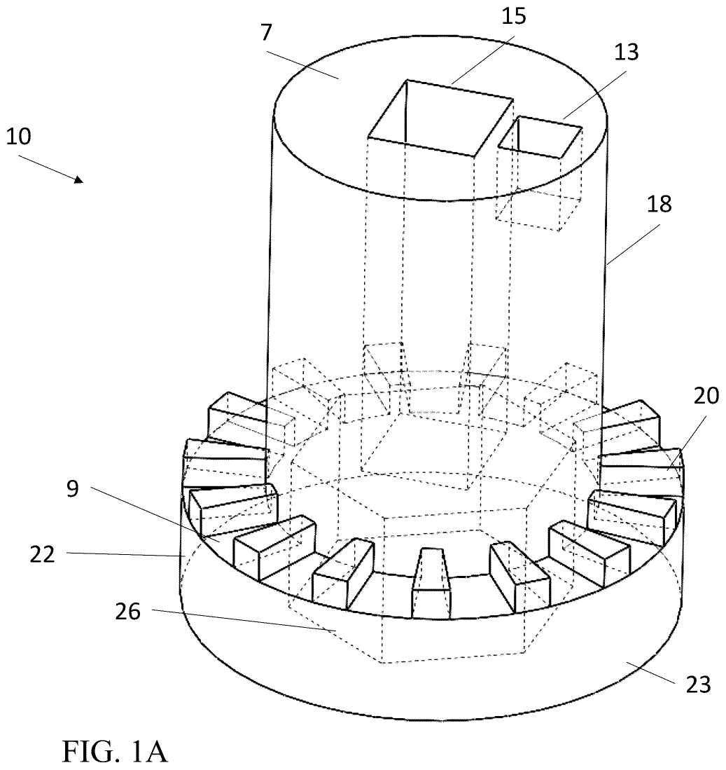

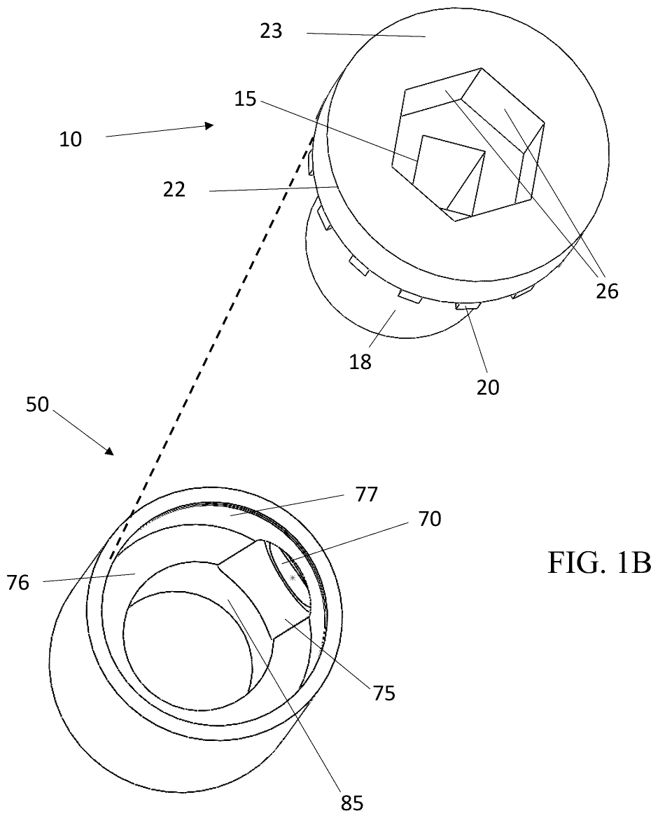

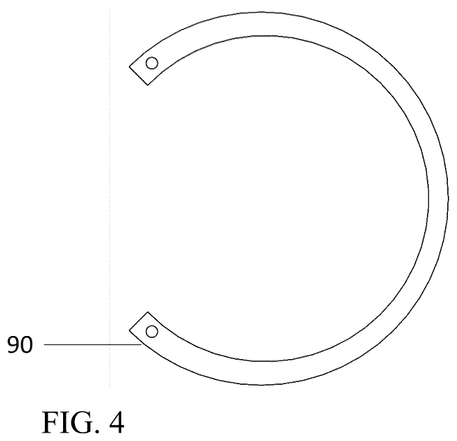

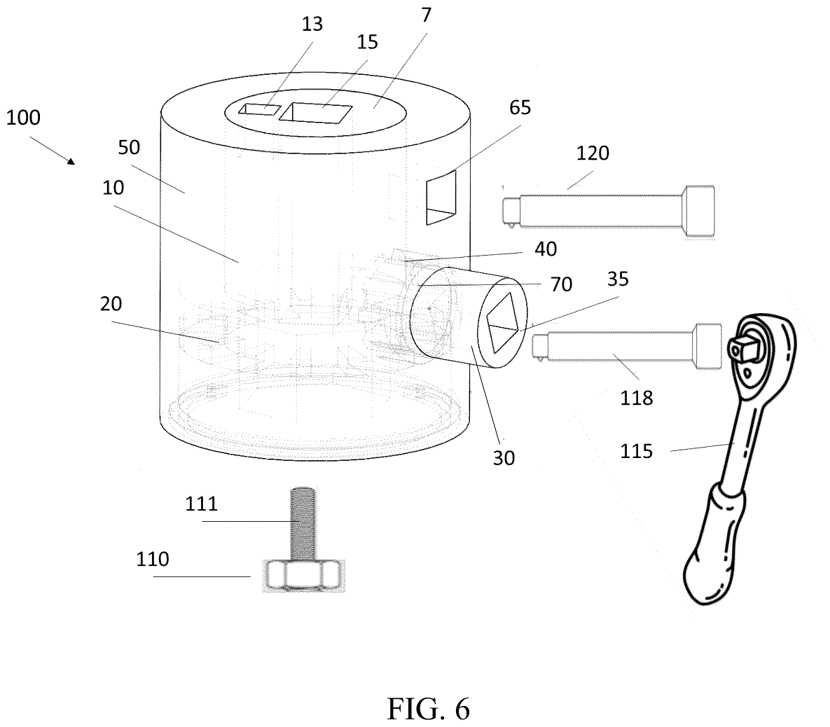

Referring now to the drawings FIGS. 1-7, and more particularly to FIGS. 1-6, there is shown a socket assembly for capturing a fastener 110 (FIG. 6), which is a gyratory socket tool 100 including an exterior cylindrical body 50, an interior cylindrical body 10, a pinion bar 30, and a retention washer 90.

Referring to FIG. 1A, the interior cylindrical body 10 has a wide diameter portion 22 (also called a flange) and a narrow diameter portion 18. The gear surface 9 of the wide diameter portion 22 includes a rack 20 (also called a gear track) around the face. The interior cylindrical body 10 may be fabricated with an inner area 15, on-center of a top face 7, which creates a thru- hole 15 for extracting longer fastener segments 111 (FIG. 6) or screws that have an open end with a fastener geometry to secure to a fastener 110 (FIG. 6). The thru-hole 15 may also accommodate use of an extension bar 120 (FIG. 6) to stabilize the gyratory socket tool 100. The thru-hole 15 accommodates space should the fastener 110 be engaged to an elongated male threaded fastener 111 (FIG. 6). A first extension hole 13 disposed on the top face 7, offset from the inner area 15, accommodates an extension bar 120 (FIG. 6) for stabilization. Due to varying operational conditions, the first extension hole 13 may be sized smaller or larger than the centered thru-hole 15. The fastener geometry, recessed on-center of a bottom face 23, may be hexagonally shaped or shaped for engagement with a specific fastener.

Referring to FIG. 1B, the interior cylindrical body 10 and an exterior cylindrical body 50 is shown. The flange 22 disposed on one end of the interior cylindrical body 10 includes a circular rack 20 extending inward from the flange 22. The flange 22 engages a wide interior face 77 of the exterior cylindrical body 50. A cylindrical hub 18 rotatably engages a narrow interior face 85, allowing for the use of one of a plurality of interior cylindrical bodies, each interior cylindrical body 10 sized for fasteners of different sizes. A radial face 76 is disposed perpendicular to the wide interior face 77 and a narrow interior face 85. The rack 20 of the interior cylindrical body 10 rotates adjacent to the radial face 76 when the gyratory socket assembly is in use. Recessed from a bottom face 23, a hexagonal inner wall 26 allows engagement of a hexagonal fastener of the fastener geometry (FIG. 1A) and is sized to mate to the fastener 110 in metric, SAE or specialized configuration. The fastener may be a nut or preferably a hexagonal nut. A plurality of interior cylindrical bodies 10 may be used with a single exterior cylindrical body 50. The hexagonal inner wall 26 and the fastener geometry (FIG. 1A) differ with each interior cylindrical body allowing for interchanging with one another for engagement with a single exterior cylindrical body 50.

The pinion hole 70 will have a larger diameter on the interior pinion hole 75 to secure the pinion bar 30 when assembled. The exterior cylindrical body 50 has a retention washer cutout 80 to secure the inner interior cylindrical body 10 with the retention washer 90 when assembled.

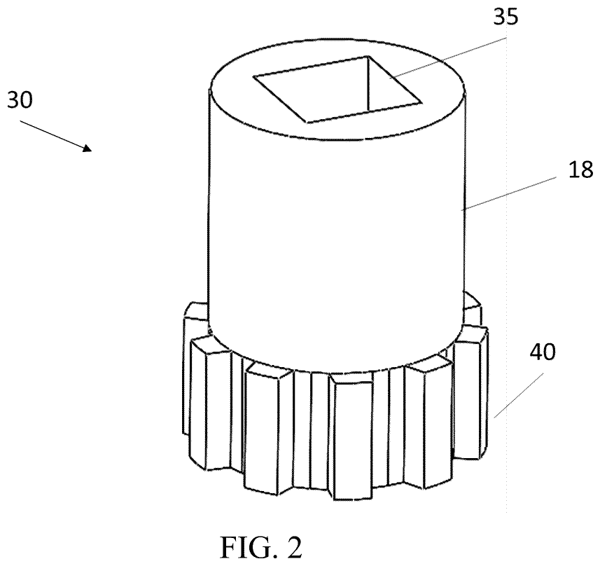

Referring the FIG. 2, the pinion bar 30 has a nominal diameter and includes a pinion 40 or gear track and a ratchet hole 35 to interface with a ratchet 115 (FIG. 6) and/or an extension bar 120 (FIG. 6). The extension bar is for manipulation of the pinion bar 30.

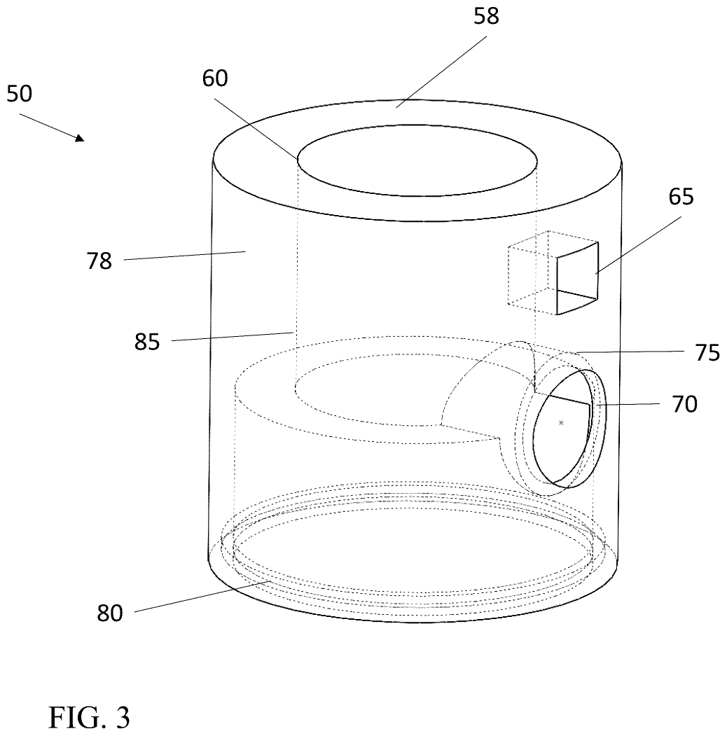

Referring the FIG. 3, the exterior cylindrical body 50 includes a cylindrical wall 78. The exterior cylindrical body 50 includes a cutout 60 for the narrow interior face 85, a pinion hole 70 and a second extension hole 65 disposed on the cylindrical wall 78 for use with an extension bar 120 (FIG. 6) to stabilize the exterior cylindrical body 50 when in use. Due to varying operational conditions, the second extension hole 65 may be sized smaller or larger than the centered thru-hole 15 (FIG. 1). A pinion hole 70 will have a larger diameter on an interior pinion hole 75 to secure the pinion bar 30 when assembled. The exterior cylindrical body 50 has a retention washer cutout 80 to secure the inner interior cylindrical body 10 with the retention washer 90 when assembled.

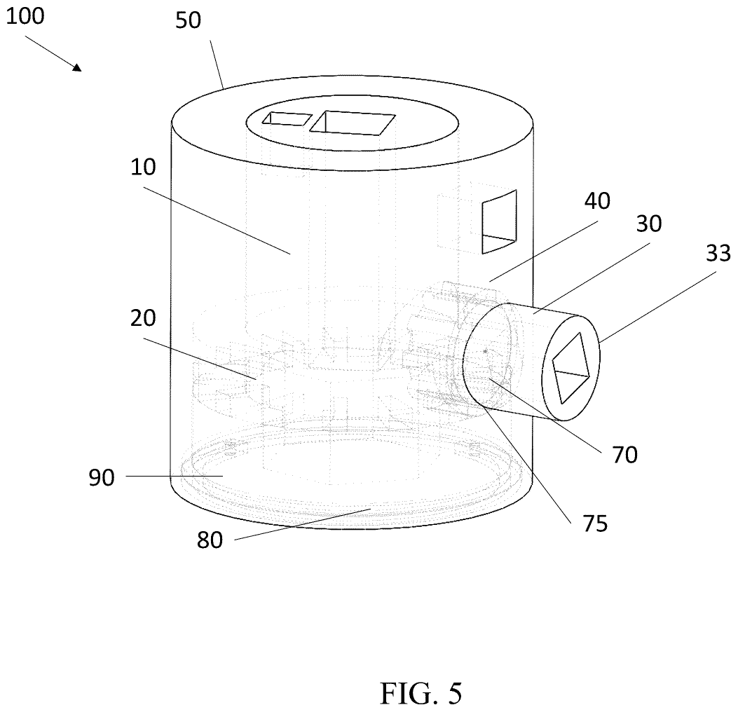

Referring to FIG. 5, the assembled gyratory socket 100, consists of the primary components including the exterior cylindrical body 50, the interior cylindrical body 10, the pinion bar 30 and the retention washer 90. The pinion bar 30 is situated through the pinion hole 70 and retained in place as the pinion gear 40 has a larger diameter than the nominal diameter 33 to situate in the interior pinion hole 75. The pinion bar 30 interfaces with the interior cylindrical body 10 via the pinion gear 40 seating with the rack 20 of the interior cylindrical body 10. The retention washer 90 seats in the retention washer cutout 80 securing the interior cylindrical body 10 to the exterior cylindrical body 50 where there remains freedom of motion for axial rotation.

Referring to FIG. 6, during, use of the gyratory socket assembly, the ratchet 115 is used to apply mechanical energy, rotating the pinion bar 30 with interface to the ratchet hole 35. The ratchet 115 may connect directly to the ratchet hole 35 or be used in conjunction with a ratchet extension bar 118 as operational environment mandates. The extension bar 120 interfaces to one of a plurality of extension bar holes 13, 15, 65, held separately from the ratchet 115, to stabilize the gyratory socket assembly 100 during rotation of the pinion bar. The pinion gear 40 of the pinion bar 30 engages with rack 20 of the interior cylindrical body 10. Rotation of the pinion bar 30 facilitates rotation of the interior cylindrical body 10.

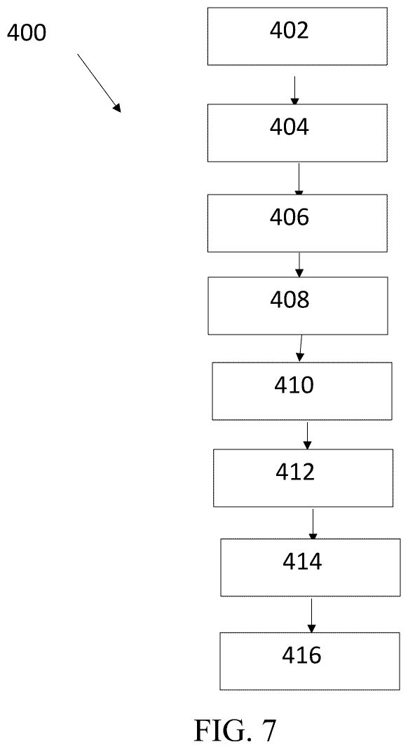

FIG. 7 is a flowchart 400 showing a method of use for using the gyratory socket assembly for adjustment of the fastener. The fastener may be a nut or preferably a hexagonal nut. The method includes engaging 402 the ratchet in the ratchet hole of the pinion bar and engaging 404 the socket extension with one of the extension holes. The method includes ensuring 406 the pinion bar is positioned in the pinion hole and engaged with the interior cylindrical body and placing 408 the socket adjacent to the elongated male threaded fastener. The method includes placing 410 the socket over the elongated male threaded fastener wherein the elongated male threaded fastener extends through the socket along a socket central axis then stabilizing 412 the gyratory socket assembly by restricting motion of the exterior cylindrical body using the socket extension. The method includes engaging 414 the ratchet to the pinion hole to apply mechanical energy to loosen or tighten the fastener with continued rotation applied 416 to the pinion bar until the fastener is at the desired position.

In another embodiment, a drill or driver is used to rotate the pinion bar.

In various embodiments, the sequence of steps is adjusted to suit the conditions and environments of operation. In additional embodiments, the socket open end is hexagonally shaped to mate with a hexagonal fastener, or the socket open end is shaped to mate with a fastener of a specific geometry.

In various example embodiments, the tool is designed for use in various industrial applications, automotive repair and maintenance, construction and assembly operations, home repair and maintenance, mechanical and engineering applications, manufacturing and production operations, aerospace and aviation maintenance and repair, marine repair and maintenance, electrical and electronic repair and maintenance, plumbing repair and maintenance, heavy machinery repair and maintenance, railway repair and maintenance, mining operations and maintenance, oil and gas operations and maintenance, and agricultural machinery repair and maintenance. These various designs contribute to the overall versatility of the tool.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A gyratory socket assembly for capturing a fastener, the gyratory socket assembly comprising:
an exterior cylindrical body having an exterior cylindrical wall, the exterior cylindrical wall having a pinion hole, and a top face at one end of the exterior cylindrical wall, and an interior cavity disposed in a center of the top face;
a pinion bar disposed through the pinion hole, the pinion bar including an exterior face having a ratchet hole, wherein a pinion gear is disposed in an interior portion of the exterior cylindrical body; and
an interior cylindrical body coaxially rotatable in the exterior cylindrical body, the interior cylindrical body having a wide diameter portion and a narrow diameter portion, wherein the wide diameter portion includes a rack to engage the pinion gear, the interior cylindrical body having a lower surface disposed in the wide diameter portion of the interior cylindrical body and a socket open end on the lower surface, the socket open end having an edge and at least one internal face along the socket open end edge, the at least one internal face for engaging the fastener.

2. The gyratory socket assembly according to claim 1, wherein a retention washer engages a groove in the exterior cylindrical body wherein the interior cylindrical body is secured inside the exterior cylindrical body by the retention washer.

3. The gyratory socket assembly according to claim 1, including a thru-hole extending from a top surface, through the interior cylindrical body, and to the socket lower surface.

4. The gyratory socket assembly according to claim 3, wherein the thru-hole is accommodating an extension bar.

5. The gyratory socket assembly according to claim 1, including a first extension hole disposed off-center on the top surface of the interior cylindrical body for engagement with the extension bar.

6. The gyratory socket assembly according to claim 1 including a second extension hole disposed on the exterior cylindrical body for engagement with the extension bar.

7. The gyratory socket assembly according to claim 1 wherein the ratchet hole is sized for a ratchet drive of at least 0.25 inches.

8. The gyratory socket assembly according to claim 5 wherein the first extension hole is sized for a ratchet drive of at least 0.25 inches.

9. The gyratory socket assembly according to claim 1 wherein the interior cylindrical body includes a socket open end, the socket open end being hexagonally shaped.

10. The gyratory socket assembly according to claim 1 wherein the socket open end is shaped for engagement with a fastener.

11. The gyratory socket assembly according to claim 3 wherein the thru-hole allows for a male threaded fastener to pass therethrough during engagement of the fastener with the interior cylindrical body.

12. A method for using the gyratory socket assembly according to claim 1 for adjustment of the fastener engaged with an elongated male threaded fastener, the method comprising:
engaging a ratchet in the ratchet hole of a pinion bar;
engaging a socket extension in one of a plurality of the extension holes;
ensuring the pinion bar is positioned in the pinion hole and engaged with the interior cylindrical body;
placing the socket adjacent to the elongated male threaded fastener;
placing the socket around the elongated male threaded fastener wherein the elongated male threaded fastener extends through the socket along a socket central axis;
rotating the ratchet engaged to the pinion hole to loosen or tighten the fastener;
stabilizing the gyratory socket assembly by restricting motion of the exterior cylindrical body using the socket extension;
continuing to rotate the socket extension until the fastener is at a desired position.

13. The method according to claim 12, wherein an interior portion of the cylindrical wall along the socket open end is hexagonally shaped.

14. The method according to claim 12, wherein an interior portion of the cylindrical wall along the socket open end is shaped for engagement with the fastener.

15. The method according to claim 12, wherein a drill engages with and rotates the pinon bar.

16. The method according to claim 12, wherein a retention washer engages a groove in the exterior cylindrical body which secures the interior cylindrical body inside the exterior cylindrical body.

17. The method according to claim 12 including a retention washer for securing the interior cylindrical body inside the exterior cylindrical body.
